(19) United States
(12) Patent Application Publication
(10) Pub. No.: US 2017/0326019 A1
(43) Pub. Date: Nov. 16, 2017

(54) MOBILE WALKING AND TRANSPORT AID DEVICE

(71) Applicant: bow2go GmbH, Wuppertal (DE)

(72) Inventors: Holger BRAMSIEPE, Wuppertal (DE); Guenter Kurt ROOD, Wuppertal (DE)

(21) Appl. No.: 15/525,469

(22) PCT Filed: Nov. 11, 2015
(86) PCT No.: PCT/EP2015/002263

§ 371 Date: May 9, 2017

(30) Foreign Application Priority Data
Nov. 11, 2014 (DE) 10 2014 016 580.9
Jan. 16, 2015 (DE) 10 2015 000 270.8

(51) Int. Cl. A61H 3/04; B62B 7/12; B62B 5/06; B62B 3/02; A61H 3/00

(52) U.S. Cl. CPC A61H 3/04; B62B 5/064; B62B 3/02; B62B 7/12; A61H 2003/002; A61H 2003/046; B62B 2206/006

(57) ABSTRACT

What is shown and described is a mobile walking and transport aid device (1) for supporting particularly persons with impaired walking ability, with a chassis (2) with wheels (3, 4) and with two outer lateral supports (5, 6), which are fixed to the chassis (2) as supporting elements for a user of the device (1). According to the invention, a provision is made that the lateral supports (5, 6) are attached to the chassis (2) such that they can be swiveled about a horizontal axis from a first, backwardly tilted position for pushing the walking and transport aid device (1) from behind and/or for supporting the user while walking inside and/or behind the walking and transport aid device (1) and/or for the user to sit on the walking and transport aid device (1) into at least one forwardly tilted position for pulling the walking and transport aid device (1) from the front.

The invention relates to a mobile walking and transport aid device, particularly for supporting persons with impaired walking ability, with a chassis with wheels and with two outer lateral supports, which are fixed to the chassis as supporting elements.

Mobile walking aid devices are known as “walkers.” Such walkers generally have a chassis with wheels as well as hand grips to support a user while walking. With walking aids, people with limited ability to walk can continue to be mobile, since the walker offers them security as they move forward. Walking aids also enable their users to walk long distances, since they can optionally serve as a chair, thus making breaks possible. Moreover, baskets mounted on walking aids also provide assistance with transporting light objects, such as groceries after shopping, for example.

In order to make it easier for the user of a mobile walking aid device to move forward and to support him when coping with inclines and slopes, an intelligent walking aid robot is known from DE 103 18 929 B3 that has a motorized drive device as well as a control device for controlling the drive device with respect to the drive speed of the wheels and the direction as a function of the action of the user on hand grips arranged on the robot. The forces and torques exerted by the user on the hand grips are detected via sensors and converted into corresponding movement commands for controlling the drive device. The walking aid robot can have a navigation system with which the robot can actively guide the user to a pre-selectable destination. Moreover, a data acquisition device can be provided in order to detect movement data during the advancement of the walking aid device and store them for later evaluation.

It is an object of the present invention to provide a mobile walking and transport aid device which, with a high level of user comfort and an aesthetically appealing appearance, enables easy use in different usage modes, particularly so as to provide support in everyday locomotion and when transporting loads. The walking and transport aid device is intended to enable an ergonomically favorable posture for the user in all usage modes while preventing rapid fatigue and postural problems on the part of the user. Another object of the invention consists in further improving the support function of walking aid devices during everyday locomotion.

In the following, the device according to the invention will be referred to for the sake of simplicity as a “walking aid device,” which does not exclude, however, the device according to the invention from also or exclusively being used as a transport aid device.

In order to achieve the abovementioned objects, one aspect of the present invention makes a provision that the lateral supports are attached to the chassis such that they can be swiveled about a horizontal axis from at least one first position that is tilted downward with respect to the direction of gravity or vertical direction, particularly for pushing the walking aid device from behind and/or for supporting a user while walking inside and/or behind the walking aid device and/or for a user to sit on the walking aid device, into at least one second forwardly tilted position, particularly in order to pull the walking aid device from the front. The lateral supports can be articulated on the chassis such that they can swivel up to 180°.

By virtue of the swivelably attached lateral supports, a simple way of using the walking aid device according to the invention in different usage modes/basic types is provided whereby an ergonomically favorable posture on the part of the user is constantly supported. In a first position of the lateral supports, which is preferably tilted backward with respect to the vertical, the walking aid device according to the invention can be used as a walker, as a shopping cart, and/or also as a chair. In contrast, when the lateral supports are arranged in the second position tilted forward with respect to the vertical, the walking aid device can be used in the manner of a hand truck/hand cart. In the first position and, optionally, in the second position, the lateral supports can be locked when a certain angle between the longitudinal axes of the two lateral supports and a horizontal base plane has been reached. In principle, it is possible for the lateral supports to be lockable in different backwardly tilted positions and/or in different forwardly tilted positions. It is thus possible for different angles between the lateral supports and a horizontal plane to be set when the backwardly and/or forwardly tilted lateral supports are locked in place.

Moreover, the structural design of the walking aid device can permit the preferably complete folding-over of the lateral support into a substantially horizontal position, thus resulting in a space-saving construction in a transport mode of the walking aid.

The sharp angle between a plane perpendicular to the vertical direction, for example a horizontal base plane through the swivel axis of the lateral support, and a lateral support, with respect to the main longitudinal axis of the lateral support, can assume a value between 40° and 90°, preferably between 60° and 80°, more preferable about 70° (for example, in walker mode, shopping cart mode, and/or chair mode). The lateral supports are then arranged so as to be tilted or sloped backward or toward the rear side of the walking aid with respect to the vertical, which enables the walking aid to be used particularly as a walker, shopping cart, or chair. The lateral supports can also be lockable while tilted backward in at least one defined angular position in relation to the horizontal, in which case a smaller angle between the horizontal and the lateral supports facilitates the use of the walking aid as a stroller (stroller mode) and a steeper position of the lateral supports facilitates the afore-described use as a walker, shopping cart, and/or chair. After the lateral supports are locked, the lateral supports can no longer be swiveled. This ensures the safe operation of the walking aid in every usage mode.

In the second, forwardly tilted position, the angle between a plane perpendicular to the direction of gravity and the longitudinal axes of the lateral supports is greater than 90° and can preferably be between 125° and 145°. The abovementioned angle refers to the obtuse angle between the horizontal plane and the longitudinal axes of the lateral supports. In principle, the angle between the horizontal plane and the longitudinal axes of the lateral supports can also be up to 180°, so that the lateral supports can be tilted forward without restrictions on the angle. Free swivelability of the lateral supports when pulling the walking aid from the front enables a posture on the part of the user that is adapted to the human body and ensures a high level of user friendliness. In hand cart mode, the lateral supports are therefore preferably not locked in a certain forwardly tilted position; rather, the angular position of the lateral supports can be adapted freely to the posture of the user and/or to the topography of the ground. It is also possible in principle, however, for the lateral supports to be locked in a forwardly tilted position in order to set a certain angle between the longitudinal axes of the lateral supports and a horizontal plane.

In transport mode, when the lateral supports are folded over substantially completely and preferably rearward, the angle between a horizontal plane and the lateral supports can be in the range between 0° and 15°. In the transporting state of the walking aid device, when the lateral supports are folded over completely, they can preferably also be locked in place. This ensures a very space-saving design of the walking aid device for transporting purposes.

All of the abovementioned angles refer to an angle measurement in the clockwise direction and to a view of the walking aid device from the side.

In principle, a separate grip element can be provided on each lateral support, in which case the grip elements are not interconnected. Another advantageous aspect of the invention that can optionally also be implemented independently of the features of the above-described embodiment of the walking aid device makes a provision for at least one common grip element connected to both lateral supports that provides support for the user in walker mode, for example, and has grip or contact surfaces for the user's hands. The grip element reinforces the arrangement of the lateral supports, thereby imparting a high level of stability to the walking aid device.

In one especially preferred embodiment, the grip element can be bow-shaped and then preferably has a center transverse brace portion arranged on a horizontal plane transverse to the direction of travel of the walking aid device and two side longitudinal brace portions that are connected to the transverse brace portion. The longitudinal brace portions of the grip element and the lateral supports preferably lie on parallel planes. The longitudinal brace portions are connected in a swiveling manner to the lateral supports. More preferably, longitudinal and transverse brace portions are embodied so as to be substantially linear and interconnected via arched portions. The grip element can then be embodied as a U-shaped or commensurately angled open bow. In principle, however, the grip element can also form a closed hoop, in which case two transverse brace portions can be connected to two side longitudinal brace portions, for example. When using the walking aid device, the user can support himself on the center transverse brace portion or, optionally, also on the longitudinal brace portions. The embodiment of the grip element as a curved handle fosters a posture that protects the user's wrist. The grip element can have a one-piece body, particularly made of plastic, that forms the longitudinal brace portions and the transverse brace portion. The grip element can consist of or be made from one or more tube sections.

In order to achieve optimal user support during use of the walking aid device according to the invention in the various usage modes, it is expedient for the grip element to be connected to the lateral supports so as to be swivelable about a horizontal axis. The swivelable attachment of the grip element to the lateral supports enables the position of the grip element to be adapted as necessary to the respective usage mode of the walking aid device and ensures a very ergonomic posture on the part of the user.

The angular positions of the grip element described below refer to the respective angle between the longitudinal axes of the lateral supports and the grip element. In particular, the angular position refers to the angle between the longitudinal axes of the lateral supports and a longitudinal axis of the grip element or of a plane through the swivel axis of the grip element on which the supporting surfaces of the grip element for the user lie. If the grip element is located in a backwardly tilted position in relation to the lateral supports, the angle refers to a counterclockwise rotation of the grip element relative to the lateral supports. If the grip element is located in a second, forwardly tilted position in relation to the lateral supports, the angle refers to a clockwise rotation of the grip element relative to the lateral supports.

It is especially expedient if the grip element can be locked in place in at least one first backwardly tilted position in relation to the lateral supports and, optionally, in at least one second forwardly tilted position in relation to the lateral supports. However, a provision is preferably made that the grip element is arranged so as to be freely swivelable and displaceable on the lateral supports, so that, when the walking aid is pulled from the front, a posture on the part of the user that is appropriate for the human body and a high level of user friendliness are ensured. In hand cart mode, the grip element is therefore preferably not locked upon reaching a certain forwardly tilted position; rather, the angular position of the grip element can be adapted freely to the posture of the user.

For example, in a shopping cart mode of the device, if the lateral supports are tilted backward in relation to the vertical, the grip element can be located in a backwardly tilted position of the longitudinal braces in relation to the lateral supports and be locked in this position. In this position, the grip element can be used by the user to push the walking aid device in front of him in the manner of a shopping cart. The grip element can be located in the same position when the walking aid device is used in a stroller mode. For this purpose, the angle between the lateral supports and the grip element can assume a value between 0° and 90°, preferably about 45°.

The grip element can preferably also be swiveled into a forwardly tilted position in relation to the lateral support and locked in place there as appropriate. In this position, the angle between the lateral supports and the grip element can assume a value between 10° and 90°, preferably between 30° and 60°, particularly about 45°. This position of the grip element characterizes the walker mode in particular if the walking aid is pushed by the user in front of him from a position behind the walking aid or between the rear wheels of the walking aid. The grip element can be in a similar or even equivalent position if the walking aid device is being used as a sitting aid. In this case, a transverse brace of the grip element can serve as a backrest when a user has set himself down onto a seat of the device. In walker mode, the grip element can also extend upward in extension of the lateral supports, thus supporting an upright gait by the user. The swivelable grip element makes it possible to change hand and grip positions during use, thereby reducing fatigue and overexertion.

The grip element can be supported by pommel-like palm rests, in which case two lateral pommel portions that are angled in relation to the longitudinal braces of the grip element can be provided as palm rests. The angle between the pommel portions and the longitudinal braces can optionally change as a function of the angular position of the grip element in the various usage modes of the walking aid device. In shopping cart mode and/or walker mode, a user can also support himself solely on the grip element or the center transverse brace of the grip element, or he can merely push the walking aid on the grip element. The same applies to the pulling of the walking aid in hand cart mode. Reduced contact as well as interaction with the grip element provides for sufficient control and support for the active user. In walker mode, the pommel portions can also be provided as bearing supporting surfaces for the heels of the user's hands. In this way, the user is given maximum support, and the user's sense of security is increased.

The pommel portions can be connected in a rigid or articulated manner to the grip element and/or to the lateral supports. Preferably, the pommel portions are embodied as rigid portions on connection elements having pivot joints, with the connection elements being connected to the lateral supports and with a connection to the grip element being established via pivot joints. The angle between the pommel portions and the longitudinal braces of the grip element then depends on the angular position of the grip element. The connecting pieces with the pivot joints can be height-adjustable in order to enable the height of the grip element to be adapted to the user's height. By virtue of the possibility of the adjustment of the height and angle of the grip element, the walking aid device can be easily adapted to a large number of users and their individual usage and handling requirements.

It is expedient if the grip element acts together with a braking device. Here, a swiveling movement of the grip element can result in the automatic activation of a braking device. The grip element and the braking device can be coupled together by means of a Bowden cable, for example, with which a swiveling movement of the grip element is converted into an adjusting movement of a brake pad of the braking device that acts against a wheel. A provision can also be made that the grip element engages in a certain angular position relative to the lateral supports, thus performing the function of a hand brake. The grip element can then act simultaneously as a backrest in the engaged hand brake position (chair mode). When the hand brake engages, visual and palpable feedback can be given to the user as a confirmation function.

In principle, non-electronic or electronic brakes can be used to slow and/or stop the walking aid device. In one especially preferred embodiment, a combination of an electronic brake with a non-electronic brake can be provided. The combination of a non-electronic brake with an electronic braking system increases the safety for the user. If the electric brake fails, a non-electronic brake is available. For example, a braking system can be provided which is operated by means of at least one hand brake lever and enables the speed to be reduced. In this context, the actuation of the hand brake lever over a first length of the possible lever path can first result in the activation of an electronic brake, and further actuation of the hand brake lever over a subsequent second length of the lever path results in the activation of a mechanical brake. This ensures that, in the event of a malfunction of the electronic braking system as a result of an interruption of the power supply, for example the walking aid device is still reliably braked through the actuation of the mechanical brake. The electronic braking system can automatically result in an intensification of the braking force, which is advantageous especially for older people. In addition, sensors can be provided to detect a hazard condition, such as an excessive inclined position of the walking aid device, for example. After detection, the walking aid can be braked automatically using the electronic brake.

At least one hand brake lever is preferably arranged in the vicinity of grip and contact surfaces of the grip element so as to be easily reachable. On different or opposing outer sides of the grip element, several hand brake levers can be provided in order to enable the equally comfortable activation of the braking functions when the lateral supports are in different positions.

In another preferred embodiment of the invention, the spacing of the wheel axles on which the rear wheels and front wheels of the walking aid are arranged can vary in accordance with the position of the lateral supports. Preferably, a structural design of the gripping aid is provided in such a manner that a change in the position of the lateral supports automatically effects a change in the spacing of the axles, which can be achieved by means of a kinematic coupling between the lateral supports and the axles. In this connection, a preferred solution makes a provision for an additional movement axis between two wheel axles of the walking aid device in order to set different spacing between the wheel axles as a function of the angular position of the lateral supports. The spacing of the axles can be varied in accordance with the usage mode. In this way, either a more compact wheelbase is created in walker mode, or an increased wheelbase and hence a greater transport surface is created in hand cart mode.

Finally, a floorboard/box and/or a seat board can be provided which can be attached in an appropriately foldable and/or detachable manner to the lateral supports. Depending on the usage mode, the floorboard and/or the seat board can result in the reinforcement of the walking aid device and/or provide a place to sit.

In one especially preferred embodiment, the walking aid device according to the invention has at least one motorized drive device for the wheels and a control device for controlling the drive device in terms of setting a drive speed and, optionally, the direction of rotation of the wheels as a function of a force and/or torque exerted by the user on the walking aid device, with the exerted force and/or torque being detected by means of at least one sensor and converted into corresponding movement commands for controlling the drive device. This makes locomotion substantially easier for the user, and the user is supported particularly when coping with inclines and slopes. Such a form of drive support is known, for example, from DE 103 18 929 B3.

The device known from DE 103 18 929 B3 uses sensors integrated into hand grips to measure the compressive and tensile forces exerted by the user on the hand grips. The forces applied are evaluated with respect to the direction of travel and speed desired by the user and converted by means of the control device into travel movements of the device. The device is set into motion only when the compressive and tensile or pushing forces applied by the user correspond to an individually predefined, permitted bandwidth. If the forces are too great, for example as a result of resting or excessive pulling after a stumble, or too little, for example as a result of hand pressure that is not strong enough or through loss of contact, the present walking aid device slows down, to a complete stop if necessary. Since the speed of the device is calculated solely from the forces applied to the hand grips, no additional forces need to be applied when traveling uphill than need to be applied in order to travel forward on a flat plane. When traveling downhill, the device does not have to be constantly braked as would be the case with a conventional walker.

To achieve the objects mentioned at the outset, another aspect of the invention makes a provision in connection with the drive-support system of a walking aid device that the control device is embodied such that the actuation of the drive device in order to set a certain drive speed as a function of a detected force and/or torque applied by the user is maintained unchanged until a subsequent additional force and/or torque applied by the user exceeds a predefined threshold value. The threshold value can be preferably in the range of zero force and/or zero torque. For example, if a force around zero is detected, the speed is maintained that was set previously on the basis of an earlier force and/or torque applied by the user. The user therefore does not need to apply a certain force or a certain torque immediately after getting the walking aid device going in order to maintain a certain drive speed of the wheels. This contributes to a high level of user friendliness, particularly for elderly people with little strength.

In another aspect of the invention, at least one sensor can be provided to detect the ascent or descent of the walking aid in order to support the user, in which case the control device is embodied such that the controlling of the drive device takes place automatically as a function of a detected ascent and/or descent of the walking aid. For example, automatic braking of the walking aid device can be provided for in this context in order to adjust the speed while traveling downhill. On the other hand, a supporting drive is provided automatically when the walking aid device is pushed or pulled uphill or on a plane.

The walking aid device according to the invention thus offers the user a supportive drive that is dependent on the user, his needs, and the surrounding terrain, with the sensor system and a measurement, control, and/or regulation system preferably being capable of converting a user-induced speed selection in a stepless manner according to needs. As another aspect of the invention, the stepless acceleration or the stepless braking of the walking aid device results in travel with little jerking, which is pleasant especially for the elderly.

Preferably, several sensors are arranged in different places on the walking aid in order to detect the application of force and/or torque by the user. It is especially preferred if force sensors and/or torque sensors are provided in the vicinity of the pivot joints by means of which the lateral supports of the walking aid device are attached in a swiveling manner to a frame of the walking aid. If the user exerts a force on the grip element of the walking aid device according to the invention, this force is transmitted via the lateral supports into the area of the sensors and detected there. The lateral supports act in the manner of a unilaterally tensioned beam, with a load on the grip element resulting in a torque near where the lateral supports are supported on the frame. In principle, sensors for detecting the application of a force and/or torque applied by the user can also be provided in or on a transverse brace and/or longitudinal brace of the grip element.

Moreover, contact sensors can be provided in the grip element in order to detect contact with the user. A control of the drive device for setting a certain drive speed may require, for example, that at least one contact sensor, preferably several contact sensors, reports a user contact. On the other hand, if the user does not contact the walking aid or does so with only one hand, a dead-man function of the control device can be activated that interrupts the power supply to the drive device. This provides a high level of safety for the user of the walking aid device.

Moreover, in the case of several sensors for detecting the application of force and/or torque by the user, a provision can also be made that an equal drive speed is specified for all of the driven wheels even when force and/or torque is applied asymmetrically, particularly unilaterally. This prevents the walking aid device according to the invention from unintentionally traveling in a curve with a radius corresponding to the amount of asymmetry of the force application or torque application on the grip element.

What is more, a freewheel function can be provided as an additional function of the control device. Here, a switching element can be arranged on the grip element or on a lateral support that has a function selection interface. Actuation of the function selection interface can activate the freewheel function, which results in an interruption of the power supply to the drive device. The wheels of the walking aid then roll without resistance and are neither driven nor braked by the drive device.

To identify an authorized user, a transponder can also be provided as part of an RFID system. The transponder contains a code identifying the user, which works with a reading device to read out this identification.

In order to achieve a compact construction and an aesthetically pleasant appearance of the walking aid device, a drive unit of the drive device can be integrated into a wheel of the walking aid, particularly a rear wheel of the walking aid. A motor integrated into the wheel rim is not visible from the outside, and the structural design of the chassis can be independent of the size and arrangement of the drive device. On the other hand, an energy store for driving the drive device can be integrated into a frame of the gripping aid drive so that it is not objectionably visible from the outside.

It will be readily understood that the abovementioned features of the drive-supporting of walking aid devices can also be the object of a method for controlling a walking aid device.

It will also be readily understood that the features of the aforedescribed walking aid devices according to the invention can be combined with one another as needed, even if this is not expressly described in detail. Each feature and aspect described above can have its own independent inventive significance. These features can represent separate aspects that are essential to the invention and are not necessarily linked to a control of the drive device in accordance with a detected ascent and/or descent of the walking aid and/or not linked to the automatic maintenance of the control of the drive device in accordance with the application of a detected force and/or torque by the user. The described features can also be combined with the features described below with reference to the drawing.

In the drawing:

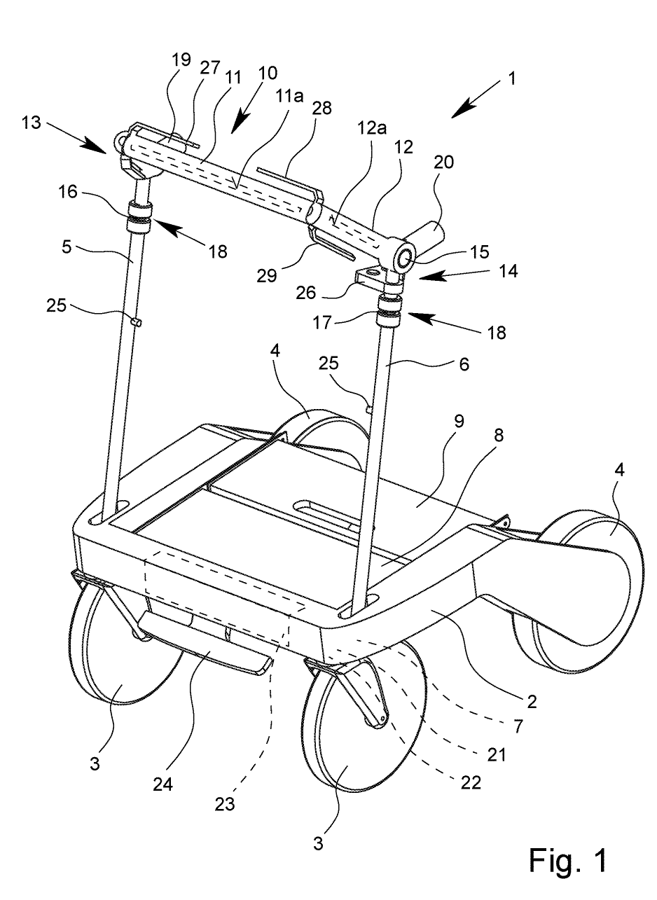

FIG. 1 shows a perspective view of a first embodiment of a mobile walking aid device according to the invention,

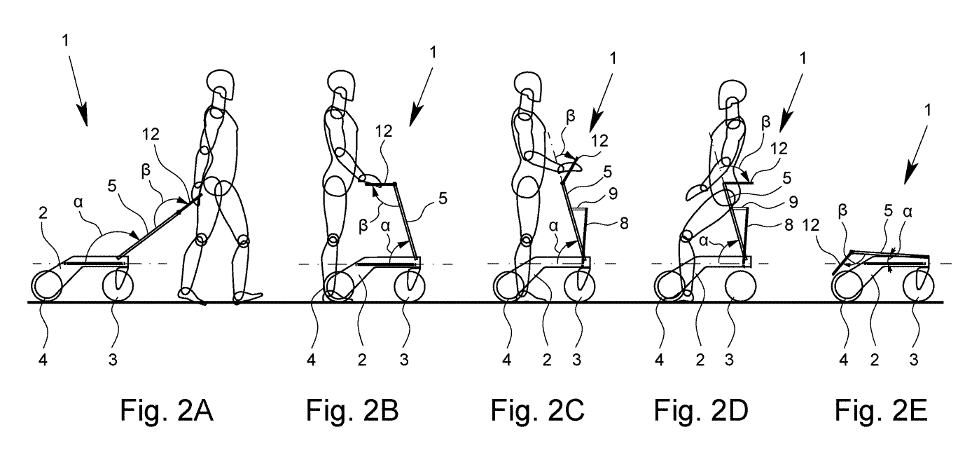

FIGS. 2A-2E show schematic representations of different usage modes of the walking aid device shown in FIG. 1,

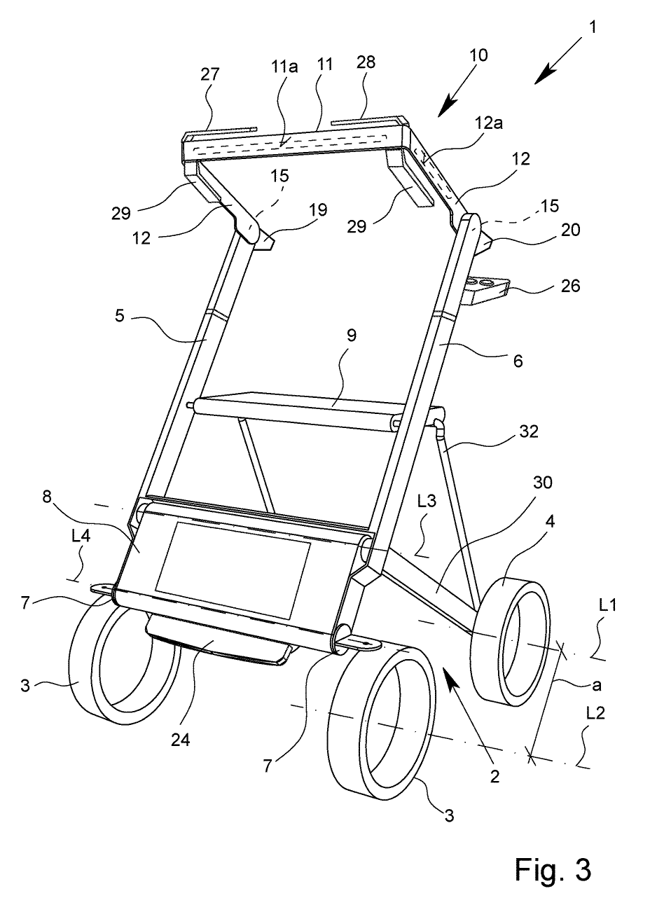

FIG. 3 shows a perspective view of another embodiment of a mobile walking aid device according to the invention,

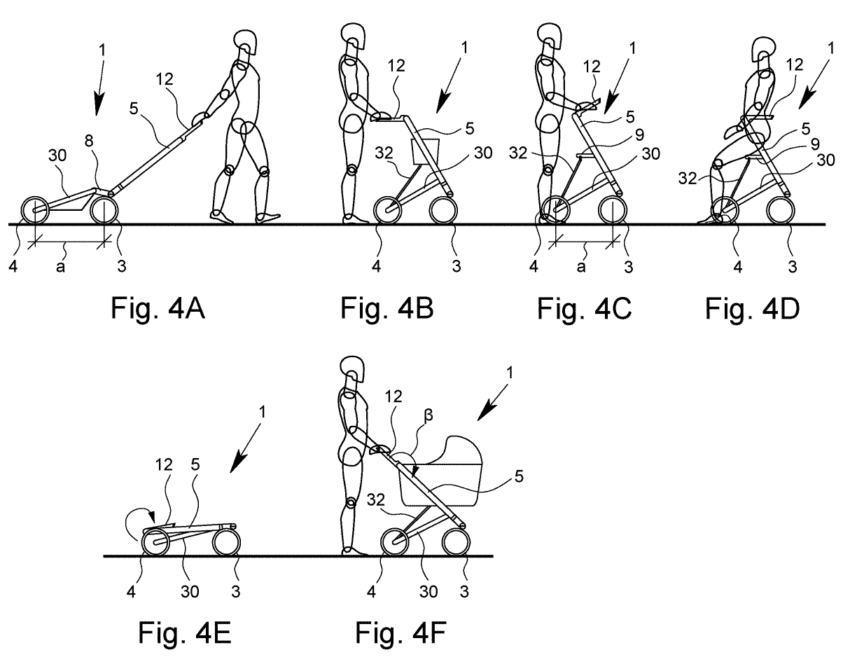

FIGS. 4A-4F show schematic representations of different usage modes of the walking aid device shown in FIG. 3, and

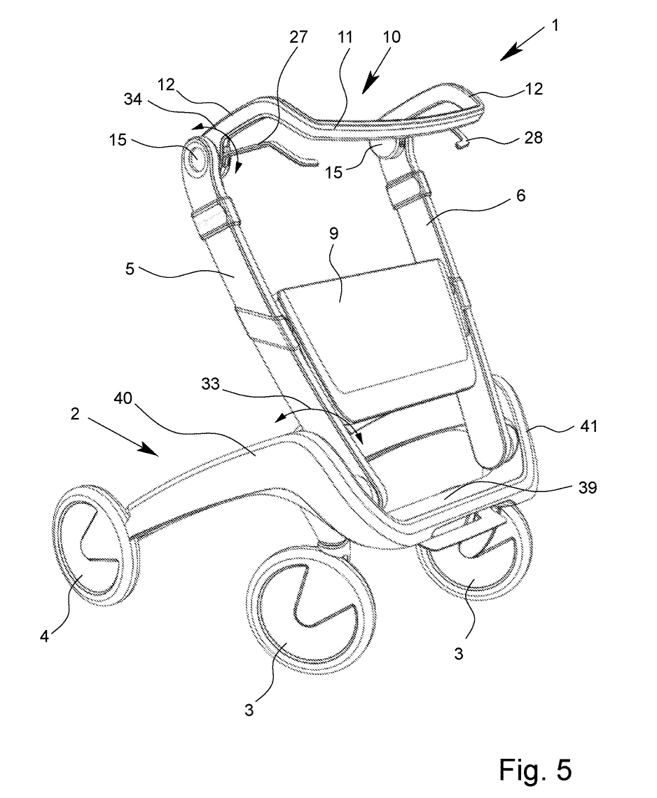

FIGS. 5-10 show perspective views of another embodiment of a mobile walking aid device according to the invention.

FIG. 1 shows a mobile walking aid device 1 for supporting persons with impaired walking ability, having a chassis 2 with two front wheels 3 (swivel casters) and two rear wheels 4 (fixed wheels). Two outer lateral supports 5, 6 are connected to the chassis 2 which form the supporting elements of the walking aid device 1. In the depicted embodiment, the lateral supports 5, 6 are embodied as rods but, in principle, they can also be formed by non-round sections. The frame design of the chassis 2 offers maximum movement clearance for a user.

As can be seen from FIGS. 2A to 2E, the lateral supports 5, 6 can be swiveled from a first position shown in FIGS. 2A to 2D, particularly in order to push the walking aid device from behind (FIG. 2B, 2C) and support a user when walking inside and/or behind the walking aid device (FIG. 2C), as well as in order for a user to sit (FIG. 2D), into at least one second forwardly tilted position for pulling the walking aid device from the front (FIG. 2A). For this purpose, the lateral supports 5, 6 are connected to the chassis 2 by means of pivot joints 7 on the interior of the frame-like chassis 2, which are not shown in FIG. 1. By virtue of the swivelable connection of the lateral supports 5, 6, the walking aid device 1 can thus be used in a hand cart mode (FIG. 2A), in a shopping cart mode (FIG. 2B), in a walker mode (FIG. 2C), and in a chair mode (FIG. 2D). Furthermore, it is possible to fold the lateral supports 5, 6 onto a bottom part 8 attached in a swiveling manner to the chassis 2 and a seat part 9 connected in a swiveling manner to the bottom part 8, which is shown in FIG. 2E. In the transport mode shown in FIG. 2E, this results in a small design size of the walking aid device 1, which is advantageous for transport. At least in the first position shown in FIGS. 2B to 2D, the lateral supports 5, 6 can be locked in place, so that the angle a between the lateral supports 5, 6 (with respect to the longitudinal axes of the lateral supports 5, 6) and a plane perpendicular to the vertical direction can be about 70°. On the other hand, in the forwardly tilted position of the lateral supports 5, 6 shown in FIG. 2A, the angle a can be between 90° and 180°, in which case the lateral supports 5, 6 can preferably assume any position in the abovementioned angular range without being locked. This results in greater user comfort when pulling the walking aid device 1 in hand cart mode.

The walking aid device 1 also has a common grip element 10 connected to both lateral supports 5, 6. The grip element 10 is embodied as a U-shaped bow and has a center transverse brace 11 and two outer longitudinal braces 12. The transverse brace 11 and the longitudinal braces 12 have grip and contact surfaces 11a and 12a.

The grip element 10 is a multifunctional component and constitutes the main control element of the walking aid device 1. The bow-like grip element 10 connects the two lateral supports 5, 6 to one another and enables the vehicle to be adapted and handled. The connection between the grip element 10 and the lateral supports 5, 6 is achieved by means of two connection elements 13, 14, with which the grip element 10 is connected in a swiveling manner to both longitudinal sides of the walking aid device 1 by means of pivot joints 15. The grip element 10 could also be embodied as a closed hoop with two transverse braces 11 that are interconnected by the longitudinal braces 12.

By virtue of the possibility of swiveling the grip element 10 and locking it in different angular positions in relation to the lateral supports 5, 6, the user's hand and grip position can be switched while using the walking aid device, thus preventing fatigue and strain. Through the multitude of handle and grip positions, it is possible to adapt to the needs of the individual user.

In shopping cart mode (FIG. 2B), the grip element 10 can be lockable in a horizontal position in a first position that is tilted backward in relation to the longitudinal axes of the lateral supports 5, 6. The angle 13 between the longitudinal braces 12 and the lateral supports 5, 6 can be about 110°.

In contrast, in a second position of the grip element 10 (walker mode according to FIG. 2C) that is tilted forward in relation to the longitudinal axes of the lateral supports 5, 6, the angle 13 between the longitudinal axes of the lateral supports 5, 6 and the longitudinal braces 12 can be about 45°. The upwardly angled grip element 10 then fosters an upright gait on the part of the user.

According to FIG. 2D (chair mode), the grip element 10 is tilted forward in relation to the longitudinal axes of the lateral supports 5, 6 but arranged and locked in a substantially horizontal position. The bow-like grip element 10 then serves simultaneously as a backrest for a user. In this case, the angle 13 between the longitudinal braces 12 and the lateral supports 5, 6 can be about 110°.

All of the above angles refer to an angle measurement in the clockwise direction.

In order to pull the walking aid device 1 (hand cart mode according to FIG. 2A), the grip element 10 can be locked in a position in which the grip element 10 lies substantially on the plane spanned by the lateral supports 5, 6. The lateral supports 5, 6 and the longitudinal braces 12 of the grip element 10 then lie on common longitudinal axes with respect to a side view of the walking aid device 1 according to FIG. 2A. The angle 13 between the lateral supports 5, 6 and the longitudinal braces 12 is 180° here. In principle, however, it is also possible for the grip element 12 to not be locked when the walking aid device is pulled in hand cart mode, so that changes in height on the ground are easily compensated for.

In transport mode, the angle a between the lateral supports 5, 6 and a plane perpendicular to the vertical direction is preferably between 0° and 15°. In transport mode, the grip element 10 is folded over onto the rear wheels 4, with it being possible for the angle 13 between the longitudinal braces 12 and the lateral supports 5, 6 to be less than 135°.

The connection elements 13, 14 are inserted into the lateral supports 5, 6 via tubular connecting portions 16, 17. An adjustment mechanism 18 can be provided in order to pull the connection elements 13, 14 upward out of the lateral supports 5, 6 and thus change the height of the grip element 10 [in relation] to the user. The adjustment mechanism 18 and the associated components, such as Bowden cables, for example, can be integrated into the chassis 2 in order to minimize the potential of a user becoming stuck and the resulting risk of injury. The actuating mechanism for the height adjustment of the grip element 10 is positioned beneath the grip element 10. The actuating mechanism can be triggered by pulling a sleeve upward. The adjustment mechanism 18 is designed such that the height of both connecting portions 16, 17 can be adjusted at the same time, so that the transverse brace 11 of the grip element 10 is always in a horizontal position during the height adjustment.

The connection elements 13, 14 each have a palm rest 19, 20. The palm rest 19, 20 acts as a bearing supporting surface for the balls of the user's hands, for example in walker mode (FIG. 2C). In shopping cart mode (FIG. 2B) and/or in walker mode (FIG. 2C), it is also possible to use only the grip element 10 or the transverse brace 11 for pushing the vehicle or supporting the user. In hand cart mode (FIG. 2A), the walking aid device is preferably pulled only on the transverse brace.

Moreover, force sensors 21 (not shown in detail in FIG. 1) are provided in the vicinity of the pivot joints 7 by means of which the lateral supports 5, 6 are attached in a swiveling manner to the chassis 2. Furthermore, drive units (motors not shown) are provided in the rear wheels 4, and a control device for controlling the drive units with respect to the setting of a drive speed and, optionally, the direction of rotation of the rear wheels 4 as a function of the application of force and/or torque by the user to the walking aid device 1. The control device is also not shown.

The application of force and/or torque via the grip and/or contact surfaces 11a, 12a of the grip element 10 is detected by means of the force sensors 21 and converted into corresponding movement commands for controlling the drive units. In the embodiment shown, force applied by the user to the grip element 10 is transferred via the lateral support 5, 6 to the force sensors 21 and detected there. The walking aid device 1 thus offers a supporting drive that is dependent on the user, his needs, and the terrain. Travel is initiated via a sensor system and a commensurately designed measurement, control, and/or regulation system capable of converting a user-induced speed selection in a stepless manner. A supporting drive is thus provided when the walking aid device is being pushed or pulled on level ground and uphill. When traveling downhill, the speed can be adapted automatically through automatic braking. Identical drive functions can be provided in the hand cart mode, shopping cart mode, and walker mode of the walking aid device. If a force around zero is detected, the speed is preferably held constant.

In order to identify the ascent and/or descent of the walking aid device 1, an additional sensor 22 can be integrated into the frame. The drive units can then be automatically controlled as a function of a detected ascent and/or descent of the walking aid device 1. The sensor 22 can be a gyroscope. The detected rise or drop of the vehicle can influence the rotational speed of the drive.

As can also be seen from FIG. 1, a rechargeable battery 23 can be integrated into the chassis 2. The same applies to charging electronics (not shown) with plug.

The angle adjustment of the lateral supports 5, 6 is actuated by a foot controller 24 that cooperates with fixing elements in the pivot joints 7 and locks or stops the lateral supports 5, 6 in a certain angular position.

The multifunctional bottom part 8 and the seat part 9 can be appropriately folded and anchored on the lateral supports 5, 6 by means of latching projections 25. By virtue of the bottom part 8 and the seat part 9, a sufficiently large transport surface is created in transport cart mode (FIG. 2A), whereas the bottom part 8 and the seat part 9 can be used to push out the lateral supports 5, 6 in walker mode. In chair mode (FIG. 2D), the opportunity to sit is provided by the seat part.

An input device 26 can be provided on the connection elements 13, 14 that has a function selection interface near the grip and/or contact surfaces 11a, 12a. A freewheel function can be activated via a switching element on the function selection interface that automatically interrupts the power supply to the drive units, so that the rear wheels 4 are able to rotate freely.

In addition, an interruption of the power supply can also be performed in transport mode according to FIG. 2E if the vehicle is folded up.

Moreover, two hand brake levers 27, 28 are arranged on the grip element 10 parallel to the transverse brace 11 and another hand brake lever 29 is arranged parallel to a longitudinal brace 12. In walker mode, a mechanical brake can be actuated using the hand brake levers 27-29, which enables the braking and stopping of the vehicle in walker mode in the event of an interruption of the power supply. In shopping cart mode, the same brake mechanism can be used as in walker mode.

In one especially preferred embodiment, a provision can be made that the grip element 10 acts together with the brake mechanism such that the brake mechanism is automatically actuated when the grip element 10 is pressed downward. The mechanical coupling between the grip element 10 and a braking device can be achieved using Bowden cables, for example, which can run on the interior of the lateral supports 5, 6.

The engagement of the grip element 10 in the chair mode according to FIG. 2D can perform the function of a non-electronic hand brake in order to enable the walking aid device 1 to be parked securely. The engagement provides visual and palpable feedback as confirmation for the user. As a backrest, the grip element 10 uses the identical mechanical brake mechanism as when used in walker mode. When the grip element 10 is pressed downward in the chair function to an engagement point, the hand brake is activated and the electronic control automatically deactivated.

The combination of a non-electronic brake with an electronic braking system can contribute to a greater level of safety for the user. If the electric brake fails, a non-electronic brake is available. Even in the event of a technical failure of the motor or control, and/or in case of an interruption in the power supply, the vehicle can be reliably braked. A braking system that is actuated by means of a hand brake lever 27-29 can make a provision, for example, that the first third of the lever path of a hand brake lever 27-29 is translated into an electronic braking effect. After that, the mechanical brake engages on the rear wheels 4 and/or front wheels 3.

Finally, in the vicinity of the grip and/or contact surfaces 11a, 12a, additional sensors can be provided in order to enable the contact of at least one hand on the grip element 10. If there is no contact or only contact on one side, this can result automatically in the triggering of a dead-man function that interrupts a power supply to the drive devices.

Another embodiment of a walking aid device 1 is shown in FIG. 3 and in FIGS. 4A to 4F. Functionally analogous components of the embodiments shown in FIGS. 1 to 4F are designated by equivalent reference symbols.

The walking aid device 1 shown in FIG. 3 can be used according to the embodiment shown in FIGS. 1 to 2E in a hand cart mode (FIG. 4A), a shopping cart mode (FIG. 4B), a walker mode (FIG. 4C), and a chair mode (FIG. 4D). By folding over the lateral supports 5, 6 and grip element 10, the walking aid device 1 can also be converted to a transport mode, which is shown in FIG. 4E. Here, the grip element 10 has been folded forward in the clockwise direction.

Moreover, the walking aid device 1 according to FIG. 4F can also be used in a stroller mode, in which case the angle 13 between a longitudinal brace 12 of the grip element 10 and a lateral support 5 can be about 180°. The lateral supports 5, 6 are thus tilted or slanted backward somewhat more than their position in shopping cart mode, walker mode, and chair mode. During use in stroller mode, the lateral supports 5, 6 do not need to be locked in the position shown in FIG. 4F.

The lateral supports 5, 6 of the walking aid device 1 shown in FIG. 3 are bar-like and attached in a swiveling manner to a chassis 2, which, besides the front wheels 3 and the rear wheels 4, also has two lateral bottom braces 30. The bottom braces 30 are attached to the rear end of a bottom part 8 so as to be swivelable about a movement axis L3. The lateral supports 5, 6 are mounted by means of pivot joints 7 at the front end of the bottom part 8. Together with the bottom part 8 and the two lateral supports 5, 6, the bottom braces 30 form a lever mechanism with an additional movement axis L3 between the wheel axes L1, L2 that makes it possible to change the distance a between the wheel axes L 1 and L2 as a function of the position of the lateral supports 5, 6. By virtue of the movement axis L3 between the wheel axes L1, L2, the wheelbases can be varied depending on the usage mode. This is shown only schematically in FIGS. 3 and 4A to 4E.

In the usage modes shown in FIGS. 4B-4E, the lateral supports 5, 6 and the bottom part 8 lie on the same plane, with the lateral supports 5, 6 being locked onto and relative to the bottom part 8 in the position shown in FIG. 3. The bottom part 8 is arranged between the lateral supports 5, 6. A swiveling movement of the lateral supports 5, 6 about the axis of rotation 7 or relative to the bottom part 8 is not possible in the locked state, which can be achieved by means of appropriate locking and/or securing means. This determines the distance a between the axes L1, L2 of the rear wheels 4 and front wheels 3 of the walking aid device 1 shown schematically in FIG. 3.

As can be seen in comparing FIGS. 4B-4E with FIG. 4F, the distance a between the longitudinal axes L1, L2 is different in the various usage modes. This is achieved by means of the lever mechanism described above.

In order to switch the walking aid device 1 into the hand cart mode shown in FIG. 4A, the rigid connection between the bottom part 8 and the lateral supports 5, 6 is disengaged and the lateral supports 5, 6 are swiveled forward relative to the bottom part 8. In hand cart mode, due to the additional movement axis L3 because of the wheel axes L1, L2 (FIG. 3), the lever mechanism results in a greater distance a between the wheel axes L1, L2. This gives the walking aid device 1 either a more compact or a more sporty wheelbase and thus also handles more dynamically or offers a larger transport surface as a result of the increased wheelbase in hand cart mode (FIG. 4A).

What is more, a grip element 10 is provided that interconnects the lateral supports 5, 6 and is attached in a swiveling manner to the lateral supports 5, 6.

A seat part 9 of the walking aid device from FIG. 3 is connected by struts 31, 32 to the chassis 2. The seat part 9 can be optionally usable and embodied so as to be detachable from the chassis 2.

Another embodiment of a mobile walking aid device 1 is shown in FIGS. 5 to 10. Functionally equivalent or similar features of the embodiments described with reference to FIGS. 1 to 10 are designated by the same reference symbols.

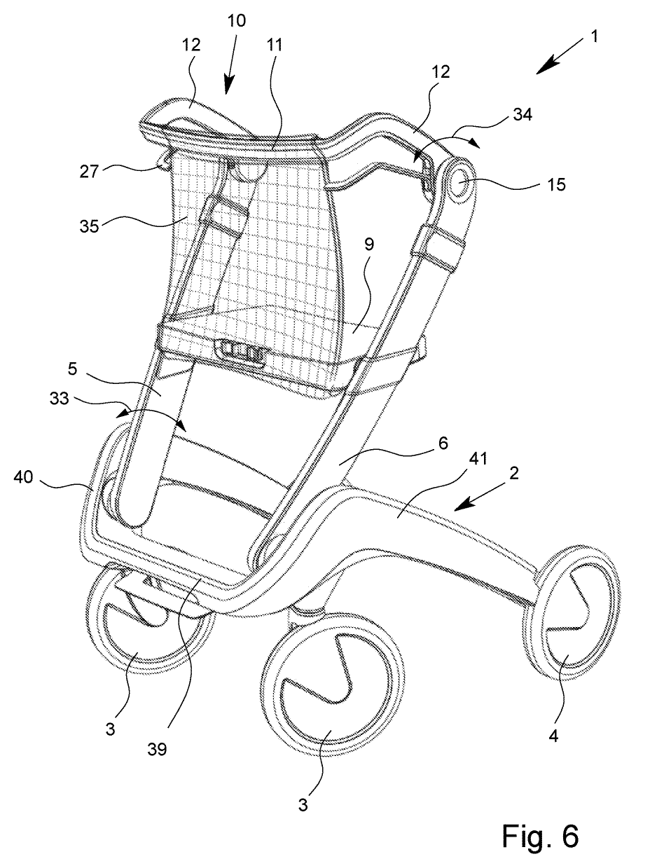

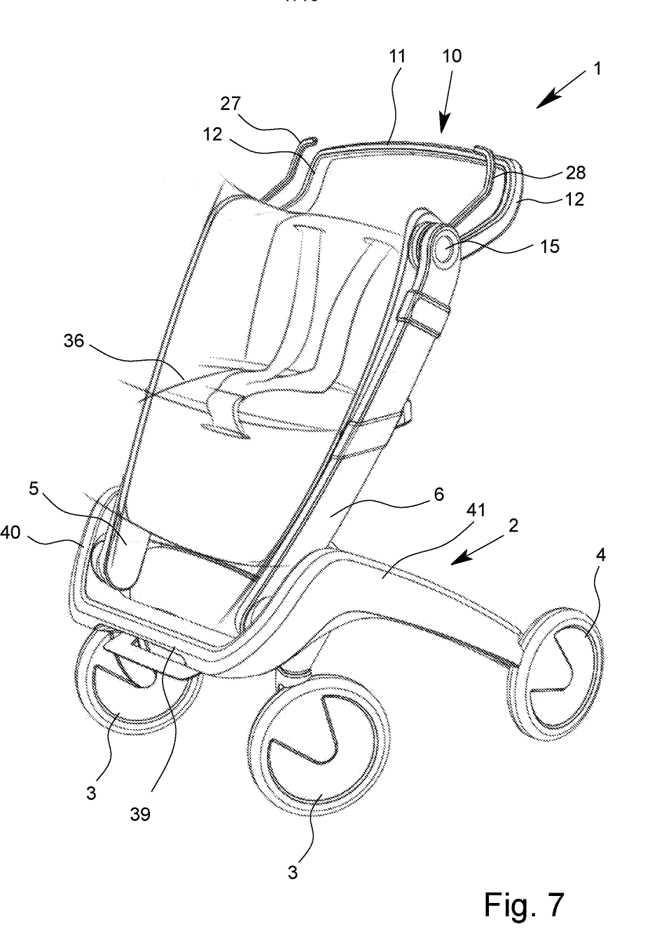

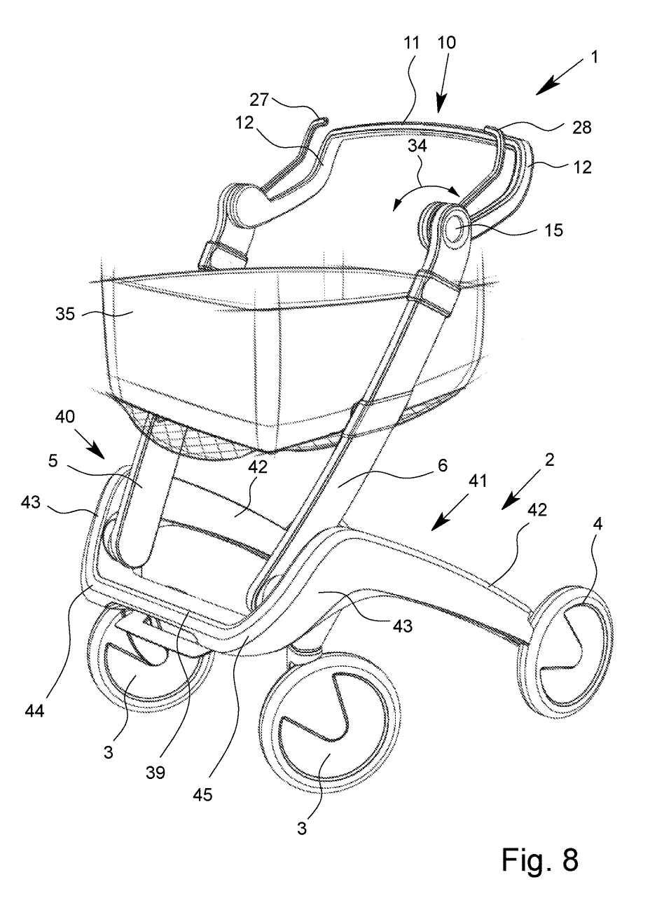

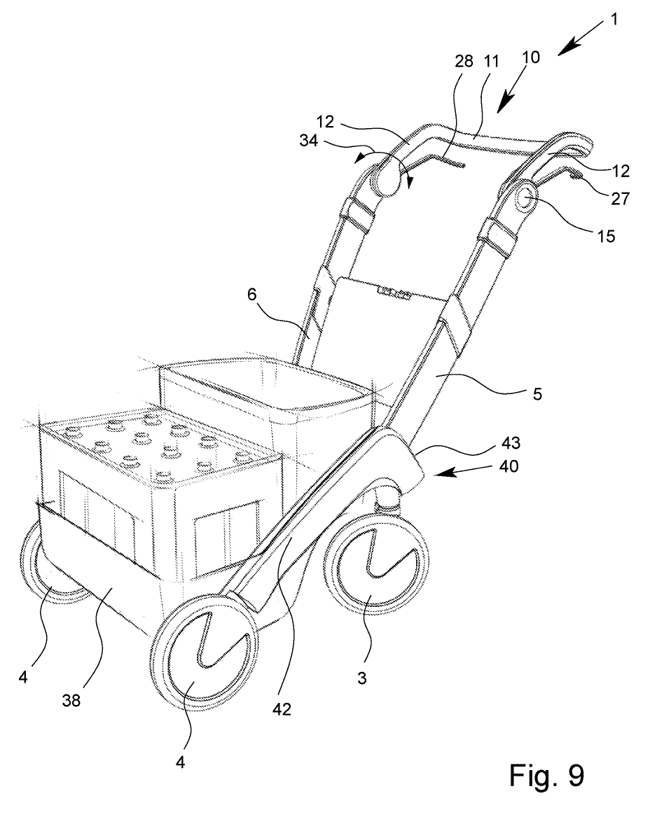

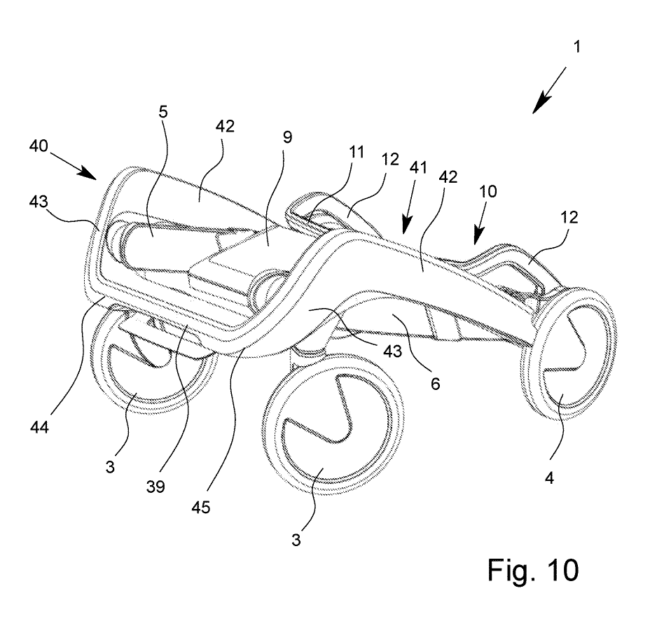

FIGS. 5 to 8 show the walking aid device 1 with lateral supports 5, 6 swiveled backward, i.e., in the direction of the rear wheels 4, whereas FIG. 9 shows the device 1 with lateral supports 5, 6 swiveled forward in relation to the vertical. In the position shown in FIG. 10, the lateral supports 5, 6 are folded completely backward. The device 1 can thus be utilized equally for different purposes, namely as a walker (FIG. 5), as a seat (FIG. 6), as a stroller (FIG. 7), as a shopping cart or transport cart (FIG. 8), or as a hand cart/push cart (FIG. 9), whereas the position of the lateral supports 5, 6 shown in FIG. 10 enables simple transport. In the transport position of the walking aid device 1, the lateral supports 5, 6 are folded over as far as possible and preferably rest on the chassis frame 2 near the rear wheels 4. A seat part 9 and a grip element 10 can then also be folded over.

In order to implement the different usage modes, the lateral supports 5, 6 have their lower ends connected to the chassis 2 in a swivelable manner by means of appropriate articulated connections. This is shown schematically in FIG. 5 by the directional arrow 33. Depending on the usage mode, the lateral supports 5, 6 can be fixed at different angles relative to the horizontal plane or locked in place relative to the chassis 2.

Moreover, the walking aid device 1 has a common grip element 10 connected to the two lateral supports 5, 6 that can be embodied as a U-shaped bow and that comprises a center transverse brace 11 and two outer longitudinal braces 12. The transverse brace 11 and/or the longitudinal braces 12 can have grip and contact surfaces as described above. The grip element 10 is connected in a swiveling manner to the lateral supports 5, 6 and can be locked in different angular positions in relation to the lateral supports 5, 6. The possibility of swiveling the grip element 10 relative to the lateral supports 5, 6 is indicated schematically in FIG. 5 by the directional arrow 34.

Possible angular adjustments of lateral supports 5, 6 and grip element 10 were already described above, so reference is made thereto.

It is not shown in detail that the walking aid device 1 can have a lockable hand brake on at least one lateral support 5, 6.

FIG. 6 shows the device 1 during use as a chair, in which case the seat part 9 can be connected by back upholstery 35 to the transverse brace 11 of the grip part 10. The grip part 10 is swiveled forward and locked in place. This ensures a high level of stability when the device 1 is used as a sitting aid.

FIG. 7 shows the use of the device as a stroller, in which case the grip part 10 is swiveled backward in relation to the longitudinal braces 12 of the grip part 10 with respect to the lateral supports 5, 6 and can be locked in this position. A seat shell 36 can be provided which can be supported on the seat part 9 and/or connected to the seat part 9. The seat part 9 can also be folded up in order to enable use of the seat shell 36. Preferably, the width of the seat shell 36 is adapted such that the seat shell 36 can be introduced between the two lateral supports 5, 6 as an integral component of the device 1.

FIG. 8 shows the device 1 adapted for the transporting of light loads, in which case a transport container 37 or a tub can be provided that can be placed onto the seat part 9 and/or connected securely to the lateral supports 5, 6. The transport container 37, in turn, is designed as an integral component of the device 1 and can be introduced between the two lateral supports 5, 6 and preferably connected in a rotationally fixed manner to the lateral supports 5, 6.

A provision can also be made that the seat part 9 can be dismounted or removed from the walking aid device 1 as needed in order to enable the installation of a seat shell 36 or transport container 37. The seat shell 36 and the transport container 37 can be separate components that can be connected as needed to the walking aid device 1 in order to enable a different use of the walking aid device 1.

FIG. 9 shows the device 1 as a transport cart, in which case the two lateral supports 5, 6 are swiveled forward with respect to the vertical. The grip part 10 is also folded over forward, and the longitudinal brace portions 12 are arranged approximately coaxially to the lateral supports 5, 6. A provision can be made that the lateral supports 5, 6 and, preferably, the grip part 10 as well can be freely swiveled and are not locked in place relative to each other and to the chassis 2. The actual transport surface can be formed by a transport box 38 which, in turn, forms an integral part of the device 1 and is adapted to the geometry of the chassis 2 such that it can be placed from above and/or the side onto the chassis 2 and detachably connected to the chassis 2. As needed, the transport box 38 can also be connected to the walking aid device 1 as a separate accessory thereof when the walking aid device 1 is to be used as a transport cart.

As can also be seen from FIG. 5, the chassis 2 has a frame section that is preferably embodied as a single piece and can be made of plastic. The frame section is formed by a floor portion 39, which connects two outer lateral portions 40, 41. The lateral portions 40, 41 are L-shaped when the device 1 is viewed from the side. Each lateral portion 40, 41 has a rear longer leg portion 42 and a front shorter leg portion 43 (FIG. 8). The frame section is connected to the rear wheels 4 at the free ends of the rear leg portions 42. The front leg portions 43 transition into the floor portion 39. The transitional portions 44, 45 of the frame section can be rounded. The lateral supports 5, 6 are arranged between the lateral portions 40, 41. The lateral supports 5, 6 can be connected in a swiveling manner with their free lower ends to the frame section. The device 1 thus has a construction that contributes to a high level of user friendliness and to an aesthetically pleasing external appearance.

It will be readily understood that the features in the embodiments of the walking aid device 1 shown in FIGS. 1 to 10 and described above can be combined with one another as needed, even if this is not expressly described in detail.

1. A mobile walking and transport aid device for supporting particularly persons with impaired walking ability, with a chassis with wheels and with two outer lateral supports connected to the chassis as supporting elements for a user of the device, characterized in that the lateral supports are attached to the chassis such that they can be swiveled about a horizontal axis from a first, backwardly tilted position for pushing the walking and transport aid device from behind and/or for supporting the user while walking inside and/or behind the walking and transport aid device and/or for the user to sit on the walking and transport aid device into at least one forwardly tilted position for pulling the walking and transport aid device from the front.

2. The walking and transport aid device as set forth in claim 1, characterized in that the lateral supports can be locked in at least one first backwardly tilted position relative to the chassis and that the angle between a plane perpendicular to the direction of gravity and the lateral supports in a backwardly tilted locked position is between 40° and 90°, preferably between 60° and 80°, more preferably about 70°.

3. The walking and transport aid device as set forth in claim 1, characterized in that, in at least one forwardly tilted position of the lateral supports, the angle between a plane perpendicular to the direction of gravity and the lateral supports is greater than 90°, preferably up to 180°, more preferably between 125° and 145°.

4. The walking and transport aid device as set forth in claim 1, characterized in that at least one common grip element connected to both lateral supports provided.

5. The walking and transport aid device as set forth in claim 4, characterized in that the grip element is embodied as an open or closed curved handle.

6. The walking and transport aid device as set forth in claim 4, characterized in that the grip element is arranged such that it can be swiveled relative to the lateral supports.

7. The walking and transport aid device as set forth in claim 4, characterized in that the grip element can be locked in at least one first position swiveled backward with respect to the lateral supports and, as needed, in at least one second position swiveled forward with respect to the lateral supports.

8. The walking and transport aid device as set forth in claim 1, characterized in that the grip element acts together with a braking device and/or in that a lever mechanism is provided with an additional movement axis between two wheel axes of the walking and transport aid device $ in order to automatically set different distances between the wheel axes as a function of the angular position of the lateral supports.

9. The walking and transport aid device for supporting particularly persons with impaired walking ability, furthermore particularly as set forth in claim 1, with a chassis with wheels and with at least one motorized drive device for the wheels, with a control device for controlling the drive device in terms of setting a drive speed and, optionally, the direction of rotation of the wheels as a function of a force and/or torque exerted by the user on the walking aid device, with the exerted force and/or torque being detected by means of at least one sensor and converted into corresponding movement commands for controlling the drive device, characterized in that the control device is embodied such that the actuation of the drive device in order to set a certain drive speed as a function of a detected force and/or torque applied by the user is kept unchanged until a subsequent additional force and/or torque applied by the user exceeds a predefined threshold value.

10. The walking and transport aid device for supporting particularly persons with impaired walking ability, furthermore particularly as set forth in claim 1, with a chassis with wheels and with at least one motorized drive device for the wheels, with a control device for controlling the drive device in terms of setting a drive speed and, optionally, the direction of rotation of the wheels as a function of a force and/or torque exerted by the user on the walking aid device, with the exerted force and/or torque being detected by means of at least one sensor and converted into corresponding movement commands for controlling the drive device, characterized in that at least one additional sensor for detecting the ascent and/or descent of the walking aid device is provided and that the control device is embodied such that the actuation of the drive device takes place automatically as a function of a detected ascent and/or descent of the walking and transport aid device.
